(19) United States
(12) Patent Application Publication
(10) Pub. No.: US 2022/0339882 A1
(43) Pub. Date: Oct. 27, 2022

(54) SYSTEMS AND METHODS FOR PERFORMING OPTICALLY CALIBRATED LARGE-AREA MICROSTEREOLITHOGRAPHY

(71) Applicant: 3D SYSTEMS, INC., Houston, TX (US)

(72) Inventors: Matthew Kenneth GELBER, Houston, TX (US); Jordan MILLER, Houston, TX (US)

(21) Appl. No.: 17/729,047

(22) Filed: Apr. 26, 2022

Related U.S. Application Data
(60) Provisional application No. 63/179,984, filed on Apr. 26, 2021.

(51) Int. Cl. B29C 64/393; B33Y 10/00; B33Y 30/00; B33Y 50/02; B29C 64/135; B29C 64/268

(52) U.S. Cl. CPC B29C 64/393; B33Y 10/00; B33Y 30/00; B33Y 50/02; B29C 64/135; B29C 64/268

(57) ABSTRACT

Provided herein is a system for producing a product. The system generally comprises a large-area micro-stereolithography system, an optical imaging system, and a controller in communication with the large-area micro-stereolithography system and the optical imaging system. The large-area micro-stereolithography system is capable of generating the product by optically polymerizing successive layers of a curable resin at a build plane. The controller is capable of directing the optical imaging system to obtain one or more optical images of the product or of a reference component located at the build plane, and adjusting a parameter associated with the large-area micro-stereolithography system based on the one or more images.

### CROSS-REFERENCE TO RELATED APPLICATIONS

This application is a non-provisional application claiming the benefit under 35 U.S.C. 119(e) of U.S. Provisional Application No. 63/179,984, filed on Apr. 26, 2021, the disclosure of which is incorporated herein by reference in its entirety.

### TECHNICAL FIELD

The subject matter described herein relates to an optically calibrated large-area microstereolithography system for producing a product, with associated apparatus and methods. This microstereolithography system has particular but not exclusive utility for 3D printing of parts.

### BACKGROUND

The concept of microstereolithography is used in rapid prototyping and small-scale production of plastic components and other complex 3D objects. An object is generated within a fluid medium by selective curing of the medium with beams of radiation focused in a build plane or print plane located at or near the medium's surface or by selective curing of the medium through volumetric exposure of the medium that delivers a desired energy dosage to different parts of the medium. A 3D model (e.g., produced using CAD software, 3D scanning, or by other means) may be subdivided into 2D slices, and each slice may be subdivided into regions. A projection apparatus can then expose an image of each region into an equivalent region of the build plane. This permits extremely high-resolution exposures, with voxels only a few tens of microns in size, across areas as large as several hundred millimeters or more. The exposed layers are then lowered into the medium with an elevator system, such that a new layer can be exposed in the now-empty build plane. In this manner, large forms can be built up rapidly, reliably, and repeatably, until a completed 3D object is produced. Such principles are described for example in U.S. Patent Publication No. 2016/0303797 to Moran, hereby included by reference as though fully set forth herein.

However, such microstereolithography systems have numerous drawbacks, including unwanted variations in beam focus and intensity across the build plane, and otherwise, that can degrade the resolution and/or beam registration of the system, resulting in lower-quality parts. Accordingly, long-felt needs exist for improved microstereolithography systems that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an optically calibrated, large-area microstereolithography (OCLAuSL) system that includes an optic system, a spatial light modulator (SLM), a beam delivery system, a bath of curable resin, an elevator system within the bath, and an optical imaging system. A 3D model (e.g., a CAD model or 3D image) of an object is subdivided into slices and slice regions. Each slice region is projected onto a corresponding region of a build plane or print plane near the surface of the curable resin bath, thus cross-linking the exposed regions into a solid polymer, until the desired voxels of the entire build plane are exposed. The elevator then lowers, bringing fresh resin into the build plane so that a new layer can be exposed. New layers are fabricated until a completed 3D object is created. Because the build plane or print plane is subdivided into multiple regions, the resolution of each exposure can be very high (e.g., voxel sizes of tens of microns or smaller), while the build plane can potentially be quite large (e.g., hundreds of millimeters or larger). The optical imaging system is used to image the build plane and calibrate the optics of the microstereolithography system, thus ensuring consistent registration, exposure, and image resolution across the entire build plane. This process is not limited to top-down printing. The projection can also be done through a window, upward into the vat, and the build platform raised for each subsequent layer.

The optically calibrated microstereolithography system disclosed herein has particular, but not exclusive, utility for 3D printing of medically useful objects, including but not limited to vasculature for artificial human organs.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the optically calibrated microstereolithography system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic representation of at least a portion of an example optically calibrated, large-area microstereolithography (OCLAuSL) system, in accordance with at least one embodiment of the present disclosure.

FIG. 2 is a schematic representation of at least a portion of an example OCLAuSL system, in accordance with at least one embodiment of the present disclosure.

FIG. 3 shows a flow diagram of an example OCLAuSL method, in accordance with at least one embodiment of the present disclosure.

FIG. 4 is a schematic representation of at least a portion of the build plane of an example OCLAuSL system, in accordance with at least one embodiment of the present disclosure.

FIG. 5 is a schematic representation of at least a portion of the build plane of an example OCLAuSL system, in accordance with at least one embodiment of the present disclosure.

FIG. 6 is a schematic, side cross-sectional view of at least a portion of an example OCLAuSL system, in accordance with at least one embodiment of the present disclosure.

FIG. 7a is a perspective view of at least a portion of the build plane of an example OCLAuSL system, in accordance with at least one embodiment of the present disclosure.

FIG. 7b is a perspective view of at least a portion of the bath of curable resin of an example OCLAuSL system, in accordance with at least one embodiment of the present disclosure.

FIG. 8 is a schematic diagram of a processor circuit, according to embodiments of the present disclosure.

FIG. 9 is a schematic showing example of an optical imaging system that is physically separated from the optic system, the SLM system, and the beam delivery system of an optically calibrated large-area microstereolithography system, according to embodiments of the present disclosure.

FIG. 10 shows an example of an optically calibrated, large-area microstereolithography system that utilizes a beamsplitter or dichroic to perform large-area microstereolithography and optical imaging through common optical elements, according to embodiments of the present disclosure.

FIG. 11 shows an exemplary spiral scan pattern, according to embodiments of the present disclosure.

### DETAILED DESCRIPTION

In accordance with at least one embodiment of the present disclosure, an optically calibrated, large-area microstereolithography system is provided which can be used for rapid manufacturing of complex, macroscopic three-dimensional components with microscopic features. The system uses a spatial light modulator (SLM) such as a liquid crystal display (LCD) screen or digital micromirror display (DMD), in coordination with a scanning optical projection system, to produce large, detailed objects through microstereolithography. A 3D computer model is subdivided into slices, each slice is subdivided into regions, and each region is communicated to the SLM to form an image. The SLM image is then projected onto a photosensitive liquid (e.g., resin) that cross-links or otherwise hardens as a result of the radiation exposure. This projection is accomplished with a scanning optical system that can direct the SLM image to different build regions of a build plane or print plane that is much larger than the SLM image itself. The imaging of new model regions on the SLM is coordinated with the optical system such that each image is directed to an appropriate portion of the build plane, with imaged model regions and build plane projection locations changing either discretely (e.g., flash-and-move imaging) or continuously. Using beam-directing optics, the projection is moved to a new position on the build plane as the SLM pattern is updated, to create a large, continuous image in the photosensitive fluid—much larger than a single SLM image. This enables very large parts or products to be fabricated which nevertheless have small feature sizes. In this manner, a single microstereolithography system covers a significant area. However, multiple microstereolithography systems can also be combined together so that their build planes cover an ever-larger area, to fabricate even larger items. By coordinating the SLM images and scanning optics of two or more microstereolithography systems, a single processor or controller can generate the necessary patterns across the combined build plane, which can be increased to any arbitrary size through the inclusion of additional microstereolithography systems.

The OCLAuSL system also includes an optical imaging system (which may for example be coaxial with the beam delivery system that projects the SLM image). The optical imaging system can be used to image the build plane. More particularly, the optical imaging system can image an item within the build plane such as the product being constructed, or a reference component or test pattern, or a mirror or other reference target with known optical properties. A CPU, processor, or controller can then analyze the image or images of the build plane, and make adjustments to parameters of the optic system such as brightness or focus, or parameters of the SLM such as grayscale properties of the SLM image, or parameters of the beam delivery system such as focus, image positioning, etc. In this way the optical imaging system can be used to calibrate the microstereolithography system either before fabrication of a new product, or in real time or near-real time during fabrication of the product.

As with other stereolithography systems, the volumetric rate of polymerization (volume turned from liquid to solid per unit time) may be determined at least in part by the critical energy of the resin and the total power of the polymerizing light. For example, some embodiments of the system described herein may be capable of polymerizing resin at rates on the order of several liters per hour, although faster and slower rates are also contemplated.

The OCLAuSL systems, apparatus, and methods can rapidly fabricate large items (e.g., tens, hundreds, or thousands of millimeters in size, or other sizes both larger and smaller) with high-resolution features (e.g., voxel sizes of tens of microns or smaller—comparable to the scale of human cells) that are consistent across the area or volume of the product. For example, the OCLAuSL systems, apparatus, and methods can fabricate items having a volume of at least about 0.1 liters (L), 0.2 L, 0.3 L, 0.4 L, 0.5 L, 0.6 L, 0.7 L, 0.8 L, 0.9 L, 1 L, 2 L, or more in a period of at most about 24 hours (h), 18 h, 16 h, 14 h, 12 h, 10 h, 8 h, 7 h, 6 h, 5 h, 4 h, 3 h, 2 h, 1 h, or less. The OCLAuSL systems, apparatus, and methods can fabricate items having a volume of at most about 2 L, 1 L, 0.9 L, 0.8 L, 0.7 L, 0.6 L, 0.5 L, 0.4 L, 0.3 L, 0.2 L, 0.1 L, or less in at most about 24 h, 18 h, 16 h, 14 h, 12 h, 10 h, 8 h, 7 h, 6 h, 5 h, 4 h, 3 h, 2 h, 1 h, or less. The OCLAuSL systems, apparatus, and methods can fabricate having a volume that is within a range defined by any two of the preceding values in an amount of time that is within a range defined by any two of the preceding values. In some cases, fabricated items can be used as-is as completed products. In other cases, fabricated items can then be used as molds or masters for casting, blow molding, injection molding, thermoforming, and other fabrication processes for polymer, metal, or ceramic objects.

Because the fabricated object or product is ultimately constructed of voxels (e.g., three-dimensional pixels), its structure may appear “pixelated” when viewed on a fine enough scale. However, it is an advantage of the present disclosure that such pixelation may occur on a scale too fine to be perceived by the human eye, and comparable to the scale of tissue layers composed of human cells (which are also “pixelated” in the sense of being constructed from indivisible subunits).

This ability to make consistently fine-featured items with large volume or cross-sectional area distinguishes the OCLAuSL systems, apparatus, and methods from other techniques, and facilitates the rapid fabrication not only of prototypes, but of finished, customized small-production-run products for individual customers. The photocurable medium may also include particles of metal, ceramic, or other materials (e.g., wood), allowing for the production of composite parts, and/or the removal of polymer and (for example) sintering of metallic or ceramic components, thus enabling the production of purely metallic or ceramic parts.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

These descriptions are provided for exemplary purposes only, and should not be considered to limit the scope of the optically calibrated, large-area microstereolithography system. Certain features may be added, removed, or modified without departing from the spirit of the claimed subject matter.

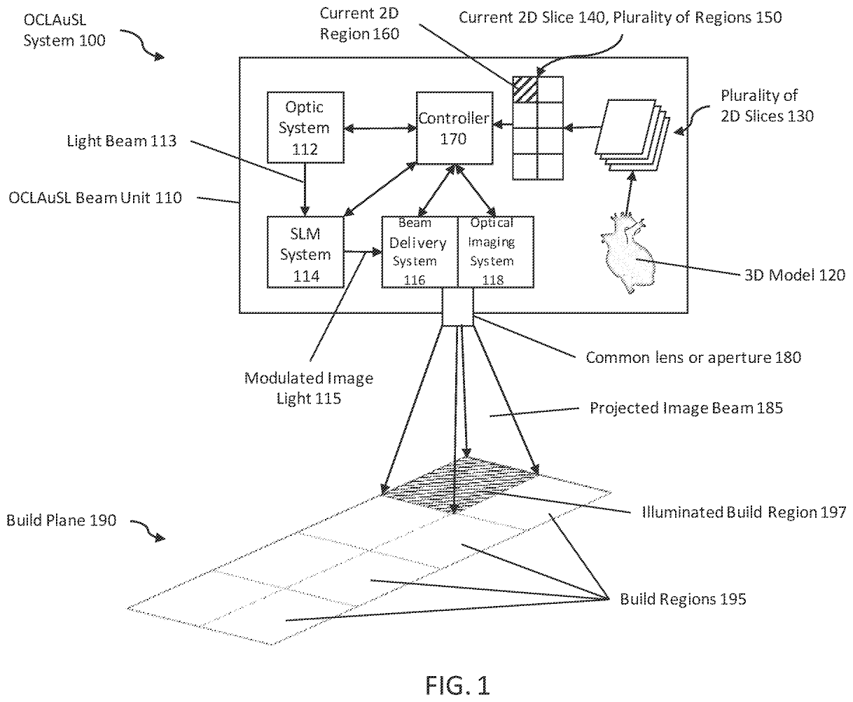

FIG. 1 is a schematic representation of at least a portion of an example optically calibrated, large-area microstereolithography (OCLAuSL) system 100, in accordance with at least one embodiment of the present disclosure. The OCLAuSL system 100 includes an OCLAuSL beam unit 110 that projects an image beam 185 onto a build plane 190.

The OCLAuSL beam unit 110 includes an optic system 112 that generates a beam of light 113, which is then cast through or onto a spatial light modulator (SLM) system 114 that generates an image. The SLM system may for example be a liquid crystal display (LCD) screen through which the beam 113 passes, or a digital micromirror display (DMD) from which the beam 113 reflects, or one or more spinning discs with apertures (as in spinning disc confocal microscopy), or another type of spatial light modulator 114 that serves the purpose of generating modulated image light 115 from the light beam 113. The SLM system may for example have a resolution of 640×480 pixels, 1024×768 pixels, 1920×1080 pixels, 2716×1528 pixels, or other resolutions both larger and smaller. In some embodiments, the optic system 112 and the SLM system 114 may be combined into a single system. For example, one could directly image an array of light sources, such as a microLED array, to produce modulated image light 115. Regardless of how it is produced, the modulated image light 115 is then passed through a beam delivery system 116, which projects the image beam 185 onto the build plane 190.

The OCLAuSL system 100 also includes a controller, central processing unit (CPU), or processor 170 that is capable of controlling or sending instructions to the optic system 112, SLM system 114, and beam delivery system 116. In some embodiments, one or more of the optic system 112, SLM system 114, or beam delivery system 116 may include its own controller 170, and in some of these embodiments these controllers 170 communicate with one another and/or with a separate controller 170.

The controller 170 includes or receives a 3D model 120 of a desired product. The controller then either divides the 3D model 120 into a plurality of 2D slices 130, or receives the plurality of 2D slices 130 from another source. For example, the 3D model may be divided into at least about 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1 million, or more slices. The 3D model may be divided into at most about 1 million, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1 slices. The 3D model may be divided into a number of slices that is within a range defined by any two of the preceding values. Each slice defines a planar cross section through the object or product to be constructed, and can be stored individually (e.g., as a series of BMP, JPEG, or other image files). For an individual slice 140, the controller then either subdivides the 2D slice 140 into a plurality of regions 150 or receives the plurality of regions 150 from another source. In an example, some slices may only have one region, whereas if regions are not overlapped, there may be hundreds of regions, and if regions are overlapped, there could potentially be millions of regions in each slice. Other arrangements are also possible and fall within the scope of the present disclosure.

These regions may also be stored as individual image files in any desired format. From the plurality of regions 150, the controller then selects a current region 160, and sends information about the current region 160 to the SLM system 114, which generates modulated image light 115 from the beam 113, which may be an image of the currently selected region 160 of the current 2D slice 140 of the 3D model 120 of the desired object or product. The modulated image light 115 is then passed through the beam delivery system 116, which may for example expand and focus the modulated image light 115 into a projected image beam 185, that includes an image of the corresponding portion of the 3D model 120, and thus of the corresponding portion of the desired product. The projected image beam 185 intersects with the build plane 190 such that the image produced by the SLM 114 is focused onto the build plane 190. The projected image beam 185 may include a monochrome (e.g., black and white) image or a grayscale image, or combinations thereof. A color image may also be used, although the color may not affect the curing of the photosensitive resin. This modulation of the projected image beam 185 may in some instances be referred to as “dynamic masking”.

The build plane 190 is subdivided into a plurality of build regions 195, each corresponding to a region 160 of the plurality of regions 150 of the currently selected 2D slice 140. A currently illuminated build region 197 is exposed by the projected image beam 185 such that photocurable resin in that portion of the build plane can be exposed and solidified by the bright portions of the projected image beam 185, while remaining liquid in the dark portions of the projected image beam 185, as described below. Selection of image regions 160 and build plane regions 197 may be discrete (e.g., flash-and-move exposure), or may be continuous. In some examples, the exposure rate can be at least 10 Hertz (Hz), 20 Hz, 30 Hz, 40 Hz, 50 Hz, 60 Hz, 70 Hz, 80 Hz, 90 Hz, 100 Hz, 110 Hz, 120 Hz, or more. In some embodiments, the exposure rate can be at most about 120 Hz, 110 Hz, 100 Hz, 90 Hz, 80 Hz, 70 Hz, 60 Hz, 50 Hz, 40 Hz, 30 Hz, 20 Hz, 10 Hz, or less. In some embodiments, the exposure rate is within a range defined by any two of the preceding values. In some examples, one could expose at the modulation rate of the spatial light modulator, such as 10-20 kHz, or at video frame rates of 60 Hz, although other rates both larger and smaller may be used instead or in addition.

In some embodiments, the system generates each region in at least about 10 microsecond (μs), 20 μs, 30 μs, 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 millisecond (ms), 2 ms, 3 ms, 4 ms, 5 ms, 6 ms, 7 ms, 8 ms, 9 ms, 10 ms, 20 ms, 30 ms, 40 ms, 50 ms, 60 ms, 70 ms, 80 ms, 90 ms, 100 ms, 200 ms, 300 ms, 400 ms, 500 ms, 600 ms, 700 ms, 800 ms, 900 ms, 1,000 ms, or more. In some embodiments, the system generates each region in at most about 1,000 ms, 900 ms, 800 ms, 700 ms, 600 ms, 500 ms, 400 ms, 300 ms, 200 ms, 100 ms, 90 ms, 80 ms, 70 ms, 60 ms, 50 ms, 40 ms, 30 ms, 20 ms, 10 ms, 9 ms, 8 ms, 7 ms, 6 ms, 5 ms, 4 ms, 3 ms, 2 ms, 1 ms, 900 μs, 800 μs, 700 μs, 600 μs, 500 μs, 400 μs, 300 μs, 200 μs, 100 μs, 90 μs, 80 μs, 70 μs, 60 μs, 50 μs, 40 μs, 30 μs, 20 μs, 10 μs, or less. In some embodiments, the system generates each region in an amount of time that is within a range defined by any two of the preceding values.

While sequentially selecting different regions 160 of the plurality of regions 150 of the current 2D slice, the controller 170 generates corresponding images with the SLM 114 and directs the beam delivery system 116 to expose them onto different selected build regions 197 of the plurality of build regions 195 of the build plane 190. In this way, a complete 2D slice of the desired product can be produced in the build plane 190. A completed 3D product can be produced by lowering the product into the photocurable resin bath with an elevator system, and sequentially exposing each 2D slice 140 of the plurality of 2D slices 130, as described below.

The OCLAuSL beam unit 110 of the OCLAuSL system 100 also includes an optical imaging system 118 under control of the controller 170. The optical imaging system is capable of imaging at least a portion of the build plane 190. In some embodiments, the optical imaging system 118 is capable of imaging the entire build plane 190, either in a single image or in successive images, whether discrete or continuously scanned. In particular, the optical imaging system 118 can be used to image an item within the build plane such as the product being constructed, or a reference component or test pattern, or a mirror or other reference target with known optical properties. The controller 170 can then analyze the image or images of the build plane, product, or reference object, and can make adjustments to parameters of the optic system 112 (e.g., brightness, focus, collimation, alignment, etc.), or parameters of the SLM system 114 (e.g., contrast, brightness, grayscale properties of the image, etc.), or parameters of the beam delivery system 116 (e.g., focus, alignment, image positioning, etc.). In this way the optical imaging system can be used to calibrate the OCLAuSL system 100, either before fabrication of a new product, or in real time or near-real time during fabrication of the product.

In some embodiments, the controller 170 is capable of processing one or more optical images of the product to determine one or more properties associated with the product. These properties may then be compared to desired properties of the product and a variety of parameters associated with the large-area microstereolithography system may be adjusted based on the difference between the properties determined from the one or more optical images and the desired properties. For example, the controller 170 may process the one or more optical images to determine regions of the product in which the resin was cured, and to what extent the resin was cured. The controller may process the one or more optical images to determine regions of the product in which the resin was not cured. These regions may then be analyzed to determine whether the regions in which the resin was cured correspond to regions in which the resin was intended to be cured, and whether the extent of curing corresponds to the intended extent of curing. The regions may be analyzed to determine whether the regions in which the resin was not cured correspond to regions in which the resin was intended not to be cured. If there is a difference between the measured level of curing and the intended level of curing, a parameter associated with the large-area microstereolithography system may be adjusted to reduce this difference. The parameter may be an intensity of illumination light (e.g., the light beam 113) emitted by the large-area microstereolithography system, a focus of the illumination light (e.g., the modulated image light 115 or the projected image beam 185), or a frequency of the illumination light. The parameters may be adjusted for the product or large-area microstereolithography system as a whole. Alternatively or in combination, the parameters may be adjusted on a pixel-by-pixel basis by adjusting a transmissivity of a corresponding pixel of the SLM system 114.

As another example, the controller 170 may process the one or more optical images to determine a physical or chemical property of the product. The physical or chemical property may be a stiffness or elastic modulus of the product. The controller may process the one or more optical images to determine the physical or chemical property in any given region of the product. The physical or chemical property may then be analyzed to determine whether the physical or chemical property corresponds to an intended physical or chemical property. If there is a difference between the measured physical or chemical property and the intended physical or chemical property, a parameter may be adjusted to reduce this difference, as described above.

The controller 170 may process the one or more optical images in a variety of manners. For example, the controller 170 may apply one or more computer vision techniques, such as centroid detection, edge detection, thresholding, blob detection, or blob area determination.

In some embodiments, the controller is capable of processing one or more optical images of a reference component located at the build plane instead of processing one or more optical images of the product itself. For example, the optical imaging system 118 may be capable of obtaining or more optical images of a substantially uniformly luminescent surface located substantially near the build plane. The substantially uniformly luminescent surface may emit light such that the relative emission of substantially every point on its surface is known (for example, substantially every point may emit the same amount of light). The controller 170 may be capable of directing illumination light from the large-area microstereolithography system to illuminate the substantially uniformly luminescent surface and directing the optical imaging system 118 to obtain the one or more images of the substantially uniformly luminescent surface. The controller 170 may be capable of directing illumination light from an illumination source not associated with the large-area microstereolithography system to illuminate the substantially uniformly luminescent surface and directing the optical imaging system 118 to obtain the one or more images of the substantially uniformly luminescent surface. The controller may then analyze the one or more images and calibrate the large-area microstereolithography system based on the one or more images. The one or more images may be analyzed to determine the response of each pixel in the optical imaging system 118. If one or more pixels of the optical imaging system 118 produce a response that is substantially different from the uniform signal expected across substantially all pixels, the parameters of the large-area microstereolithography system may be altered to obtain the uniform response across substantially all pixels. For example, the parameters of the optical imaging system may be altered to obtain the uniform response across substantially all pixels. This procedure may be implemented before, during, or after the production of a product by the large-area microstereolithography system.

In some embodiments, the system 100 further comprises a test substrate (not shown in FIG. 1). In some embodiments, the test substrate is located substantially near the print plane 190. For example, in some embodiments, the test substrate is located at least about 0.1 millimeters (mm), 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 6 mm, 7 mm, 8 mm, 9 mm, 10 mm, or more from the print plane 190. In some embodiments, the test substrate is located at most about 10 mm, 9 mm, 8 mm, 7 mm, 6 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, or less from the print plane 190. In some embodiments, the test substrate is located a distance from the print plane 190 that is within a range defined by any two of the preceding values. In some embodiments, the controller 170 is further capable of directing illumination light from the large-area microstereolithography system to illuminate the test substrate. In some embodiments, the controller 170 is further capable of directing the optical imaging system to obtain one or more test images of the test substrate. In the manner, contrast from the test substrate may be imaged. The controller may then analyze the one or more test images and calibrate the large-area microstereolithography system based on the one or more test images.

Such a test substrate may have optical features located at precisely known locations. When one of these optical features enters a field-of-view (FOV) of the optical imaging system 118, such information can be used to precisely determine the optical alignment of the optic system 112, the SLM system 114, or the beam delivery system 116, or to precisely determine the mechanical alignment of the product being built. Misalignments can thus be compensated for.

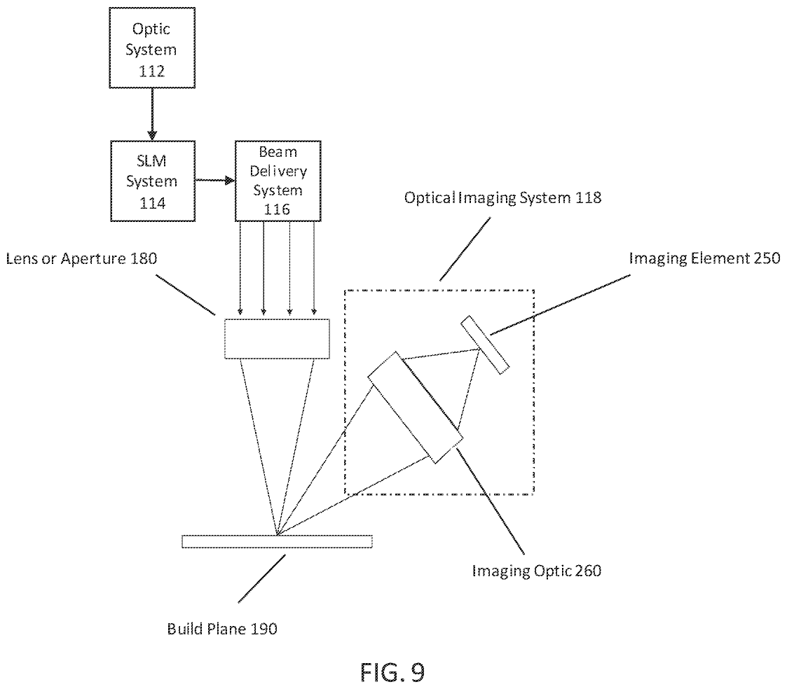

In some embodiments, the optical imaging system 118 and the beam delivery system 116 may share at least one common lens or aperture 180, although in other embodiments each may include their own separate lenses and apertures as may be appreciated by a person of ordinary skill in the art. In some cases, the optical imaging system 118 may be physically separated from the optic system 112, SLM 114, and beam delivery system 116, as shown in FIG. 9. For example, the optical imaging system 118 may be located in a separate housing, and/or may be located proximate to the build plane 190.

In some embodiments, the optical imaging system 118 is located substantially near the build plane 190. For example, the optical imaging system 118 may be located at least about 1 centimeter (cm), 2 cm, 3 cm, 4 cm, 5 cm, 6 cm, 7 cm, 8 cm, 9 cm, 10 cm, 20 cm, 30 cm, 40 cm, 50 cm, 60 cm, 70 cm, 80 cm, 90 cm, 100 cm, or more from the build plane 190. The optical imaging system 118 may be located at most about 100 cm, 90 cm, 80 cm, 70 cm, 60 cm, 50 cm, 40 cm, 30 cm, 20 cm, 10 cm, 9 cm, 8 cm, 7 cm, 6 cm, 5 cm, 4 cm, 3 cm, 2 cm, 1 cm, or less from the build plane 190. The optical imaging system 118 may be located a distance from the build plane 190 that is within a range defined by any two of the preceding values.

Before continuing, it should be noted that the examples described above are provided for purposes of illustration, and are not intended to be limiting. Other devices and/or device configurations may be utilized to carry out the operations described herein.

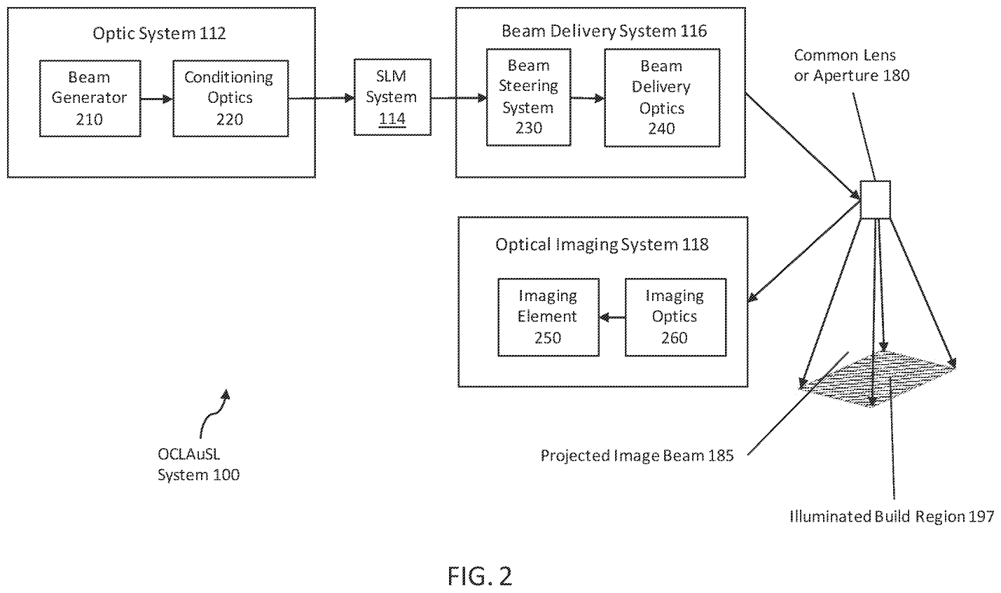

FIG. 2 is a schematic representation of at least a portion of an example OCLAuSL system 100, in accordance with at least one embodiment of the present disclosure. OCLAuSL system 100 includes an optic system 112, a spatial light modulator (SLM) system 114, a beam delivery system 116, and an optical imaging system 118. In some embodiments, the beam delivery system 116 and optical imaging system 118 may share a common lens or aperture 180, although in other embodiments this is not the case. In some embodiments, the common lens or aperture is or includes a beamsplitter.

The beam delivery system 116 projects an image beam 185 onto a selected build region 197. In an example, the projected image beam 185 contains all the wavelengths of light generated by the optic system 112. In other examples, the projected image beam contains only selected wavelengths of the light generated by the optic system 112 (for example, those actinic wavelengths most suited to curing the photosensitive resin in the build plane).

The optical imaging system is capable of imaging the selected build region. In some embodiments, the optical imaging system images the selected build region 197 using reflected light from the projected image beam. In other embodiments, the optical imaging system illuminates the selected build region 197 with a different portion of the light generated by the optic system (for example, those non-actinic wavelengths less suited to curing the photosensitive resin, or most suited to imaging selected features in the build plane).

The optic system 112 may for example include a beam generator 210 and conditioning optics 220. The beam generator 210 may for example be or include a light emitting diode (LED), a superluminescent diode (SLD), a laser, a halogen bulb or other incandescent source, a xenon flash lamp or any other electric arc source, a limelight or other candoluminescent source, or other light-generating components known in the art, including combinations thereof. In some embodiments, the light may be conditioned such that it comprises Kohler illumination. The beam generator 210 may generate light of a single wavelength, or a narrow range of wavelengths, or a broad range of wavelengths. Emitted wavelengths may include infrared, visible, and ultraviolet wavelengths. The optic system 112 may also include conditioning optics 220. The conditioning optics 220 may for example include a collimating lens or other collimating optics (e.g., to tighten the beam), beam homogenizer, a beam expander (to match the size of the beam to the size of the SLM 114), one or more filters (to transmit certain wavelengths of light, such as actinic wavelengths capable of initiating photochemical reactions, while reflecting or absorbing other wavelengths, such as non-actinic wavelengths), one or more mirrors, one or more lenses, one or more beam splitters, one or more pupils, one or more shutters, one or more beam expanders or beam reducers, and/or other optics known in the art as needed to direct the generated light onto the SLM system 114 and/or to illuminate the selected build region 197 for the optical imaging system. The conditioning optics 220 may also include one or more sensors capable of monitoring the status of the beam (e.g., brightness, alignment, etc.).

The beam delivery system 116 may for example include a beam steering system 230 and beam delivery optics 240. The beam steering system 230 may for example be or include a steerable mirror, such as a galvanometer mirror or spinning polygonal mirror. In an example, the beam steering system is a micro-actuated mirror with an accuracy of 10 microns or better, configured to deliver the SLM image to the proper place in the resin bath under control of the controller 170 (see FIG. 1). In some embodiments, the beam steering system comprises one or more galvanometer mirrors that are discretely or continuously steerable over two dimensions, and may be operable by one or more stepper motors or servo motors. In some embodiments, the beam steering system comprises one or more spinning polygonal mirrors that are discretely steerable over one dimension, and may be operable by one or more motors. A beam steering system comprising one or more spinning polygonal mirror may increase the rate at which different build regions at the build plane illuminated. A rate of rotation of such a spinning polygonal mirror may by proportional to the rate at which the different build regions at the build plane are illuminated. In comparison to a galvanometer, which may be required to change its direction of travel during beam steering, a spinning polygonal mirror may not be required to change its direction of travel and may thus be rotated very quickly and deliver a substantial increase in the rate at which the different build regions at the build plane are illuminated.

The beam delivery system 116 may also include beam delivery optics 240. The beam delivery optics 240 may for example include one or more mirrors, one or more beam expanders or beam reducers (e.g., to match the size of the projected image beam 185 to the size of the selected build region 197), one or more focusing lenses (e.g., to ensure that the focal plane of the projected image beam 185 is coplanar with the selected build region 197), one or more collimating lens or other collimating optics, one or more apertures, one or more scan lenses (e.g., flat field scan lenses), and/or other optics known in the art as needed to deliver the projected image beam 185 from the beam steering system 230 to the selected build region 197. The build plane occurs at the top layer of a bath of photo-curable material, and exposes or cures the desired pattern into the material, as described below.

Kohler illumination light may be particularly useful, as such light may prevent an image of the optic system 112, the beam generator 210, the conditioning optics 220, the SLM system 114, the beam delivery 116, the beam steering system 230, the beam delivery optics 240, or the lens or aperture 180 from appearing in the build plane 190. The Kohler illumination may be generated by de-focusing light emitted by the beam generator 210.

The optical imaging system 118 may for example include an imaging element 250 such as a charge coupled device (CCD) array or complementary metal oxide semiconductor (CMOS) camera, as well as imaging optics 260. The imaging optics 260 may include lenses, mirrors, beam splitters, shutters, pupils, and other optical components as will be understood by a person of ordinary skill in the art, that serve the function of delivering an accurate image of the build plane 190 or the current build region 197 to the imaging element 250 so that an accurate image can be captured by the imaging element 250 and analyzed (e.g., by the controller 170 of FIG. 1). Depending on the implementation, the optical imaging system 118 may be a bright field imaging system, fluorescence imaging system, reflectance imaging system, scattering imaging system, refractive index difference imaging system, luminescence imaging system, ellipsometry imaging system, differential interference contrast imaging system, phase contrast microscopy imaging system, Raman scattering imaging system, spectral imaging system, optical coherence tomography (OCT) imaging system, interferometric imaging system, or other type of imaging system as known in the art. In some embodiments, the optical imaging system 118 may be replaced by, or may include, a non-optical imaging system 118 such as an ultrasound imaging system or photoacoustic imaging system. In these cases, the imaging element 250 may be or include an appropriate imaging element for the selected imaging modalities (e.g., an ultrasound or photoacoustic transducer array), and the imaging optics 260 may include or be replaced by appropriate beam conditioning systems 260 (e.g., microbeamformers, A/D converters, etc.) for the selected imaging modalities, as understood in the art.

In some embodiments, an ultrasound imaging system or a photoacoustic imaging system may be capable of detecting a pressure wave. In some embodiments, the ultrasound imaging system or the photoacoustic imaging system is located substantially near to the build plane 190. For example, in some embodiments, the ultrasound imaging system or the photoacoustic imaging system is located within at least about 0.1 cm, 0.2 cm, 0.3 cm, 0.4 cm, 0.5 cm, 0.6 cm, 0.7 cm, 0.8 cm, 0.9 cm, 1 cm, 2 cm, 3 cm, 4 cm, 5 cm, 6 cm, 7 cm, 8 cm, 9 cm, 10 cm, or more of the build plane 190. In some embodiments, the ultrasound imaging system or the photoacoustic imaging system is located at most about 10 cm, 9 cm, 8 cm, 7 cm, 6 cm, 5 cm, 4 cm, 3 cm, 2 cm, 1 cm, 0.9 cm, 0.8 cm, 0.7 cm, 0.6 cm, 0.5 cm, 0.4 cm, 0.3 cm, 0.2 cm, 0.1 cm, or less of the build plane 190. In some embodiments, the ultrasound imaging system or the photoacoustic imaging system is located a distance from the build plane 190 that is within a range defined by any two of the preceding values. The ultrasound imaging system or the photoacoustic imaging system may be capable of detecting changes in the propagation of pressure waves that permeate the product being constructed at the build plane 190. Such changes may be dependent upon mechanical properties of the product, such as the elastic modulus of the product. Thus, the ultrasound imaging system or the photoacoustic imaging system may be capable of providing information about the elastic modulus of the product. Such information may be used to adjust one or more parameters associated with the large-area microstereolithography system, as described herein.

In some embodiments, the optical imaging system 118 may be capable of directing optical imaging light to the build plane 190. In some embodiments, the optical imaging light may have an optical intensity or irradiance that is high enough to generate images of the build plane 190 but low enough to avoid polymerizing resin located at the build plane 190. For example, in some embodiments, the optical imaging light has an irradiance of at least about 1 microwatt-centimeter⁻² (μW-cm⁻²), 2 μW-cm⁻², 3 μW-cm⁻², 4 μW-cm⁻², 5 μW-cm⁻², 6 μW-cm⁻², 7 μW-cm⁻², 8 μW-cm⁻², 9 μW-cm⁻², 10 μW-cm⁻², 20 μW-cm⁻², 30 μW-cm⁻², 40 μW-cm⁻², 50 μW-cm², 60 μW-cm⁻², 70 μW-cm⁻², 80 μW-cm², 90 μW-cm², 100 μW-cm², 200 μW-cm⁻², 300 μW-cm², 400 μW-cm⁻², 500 μW-cm², 600 μW-cm⁻², 700 μW-cm⁻², 800 μW-cm⁻², 900 μW-cm⁻², 1,000 μW-cm², or more. In some embodiments, the optical imaging light has an irradiance of at most about 1,000 μW-cm², 900 μW-cm⁻², 800 μW-cm⁻², 700 μW-cm⁻², 600 μW-cm², 500 μW-cm², 400 μW-cm⁻², 300 μW-cm², 200 μW-cm², 100 μW-cm², 90 μW-cm², 80 μW-cm², 70 μW-cm⁻², 60 μW-cm², 50 μW-cm², 40 μW-cm⁻², 30 μW-cm², 20 μW-cm², 10 μW-cm², 9 μW-cm², 8 μW-cm², 7 μW-cm², 6 μW-cm², 5 μW-cm², 4 μW-cm², 3 μW-cm², 2 μW-cm², 1 μW-cm², or less. In some embodiments, the optical imaging light has an irradiance that is within a range defined by any two of the preceding values.

In some embodiments, the optical imaging light has an irradiance which is sufficient to polymerize the resin. In such cases, the optical imaging light may be directed to the build plane for a short enough time to avoid substantially polymerizing the resin. Thus, it may be useful to limit the total optical energy directed to the build plane 190. For example, in some embodiments, the optical imaging light has a total optical energy of at least about 1 microjoule-centimeter⁻² (μJ-cm⁻²), 2 μJ-cm², 3 μJ-cm², 4 μJ-cm², 5 μJ-cm², 6 μJ-cm², 7 μJ-cm⁻², 8 μJ-cm², 9 μJ-cm², 10 μJ-cm⁻², 20 μJ-cm⁻², 30 μJ-cm², 40 μJ-cm², 50 μJ-cm², 60 μJ-cm², 70 μJ-cm⁻², 80 μJ-cm⁻², 90 μJ-cm⁻², 100 μJ-cm², 200 μJ-cm², 300 μJ-cm², 400 μJ-cm⁻², 500 μJ-cm⁻², 600 μJ-cm⁻², 700 μJ-cm⁻², 800 μJ-cm⁻², 900 μJ-cm², 1,000 μJ-cm², or more. In some embodiments, the optical imaging light has a total optical energy of at most about 1,000 μJ-cm⁻², 900 μJ-cm⁻², 800 μJ-cm⁻², 700 μJ-cm⁻², 600 μJ-cm⁻², 500 μJ-cm⁻², 400 J-cm⁻², 300 μJ-cm⁻², 200 μJ-cm⁻², 100 μJ-cm⁻², 90 μJ-cm⁻², 80 μJ-cm², 70 μJ-cm², 60 μJ-cm⁻², 50 μJ-cm², 40 μJ-cm⁻², 30 μJ-cm², 20 μJ-cm², 10 μJ-cm², 9 μJ-cm⁻², 8 μJ-cm⁻², 7 μJ-cm⁻², 6 μJ-cm², 5 μJ-cm², 4 μJ-cm⁻², 3 μJ-cm⁻², 2 μJ-cm², 1 μJ-cm⁻², or less. In some embodiments, the optical imaging light has a total optical energy that is within a range defined by any two of the preceding values. In some embodiments, the optical imaging light has an exposure time of at least about 0.1 seconds (s), 0.2 s, 0.3 s, 0.4 s, 0.5 s, 0.6 s, 0.7 s, 0.8 s, 0.9 s, 1 s, or more. In some embodiments, the optical imaging light has an exposure time of at most about 1 s, 0.9 s, 0.8 s, 0.7 s, 0.6 s, 0.5 s, 0.4 s, 0.3 s, 0.2 s, 0.1 s, or less. In some embodiments, the optical imaging light has an exposure time that is within a range defined by any two of the preceding values.

In some embodiments, the optical imaging light is filtered to remove wavelengths of light that may polymerize the resin at the build plane 190. For example, in some embodiments, the system 100 further comprises one or more filters (not shown in FIG. 1 or FIG. 2) capable of filtering one or more wavelengths of light from the illumination light or the modulated illumination light. In some embodiments, the one or more filters comprise interference filters. In some embodiments, the one or more filters comprise absorptive filters. In some embodiments, the one or more filters are low-pass filters. In some embodiments, the low-pass filters are capable of transmitting light having a wavelength of at most about 325 nanometers (nm), 330 nm, 335 nm, 340 nm, 345 nm, 350 nm, 355 nm, 360 nm, 365 nm, 370 nm, 375 nm, 380 nm, 385 nm, 390 nm, 395 nm, 400 nm, 405 nm, 410 nm, 415 nm, 420 nm, 425 nm, 430 nm, 435 nm, 440 nm, 445 nm, 450 nm, or more. In some embodiments, the one or more filters are band-pass filters. In some embodiments, the band-pass filters are capable of transmitting light having a wavelength in a range from about 325 nm to about 375 nm, about 335 nm to about 385 nm, about 340 nm to about 385 nm, about 340 nm to about 390 nm, about 345 nm to about 395 nm, about 350 nm to about 400 nm, about 355 nm to about 405 nm, about 360 nm to about 410 nm, about 365 nm to about 415 nm, about 370 nm to about 420 nm, about 375 nm to about 425 nm, about 380 nm to about 430 nm, about 385 nm to about 435 nm, about 390 nm to about 440 nm, about 395 nm to about 445 nm, or about 400 nm to about 450 nm.

In some embodiments, the optical imaging light is directed to the build plane 190 by the SLM system 114. In some embodiments, the optical imaging light has a color that does not polymerize resin at the build plane 190. Projecting the optical imaging light through the SLM system 114 may eliminate the need for additional optical components in the system 100 and may make the system 100 more compact. Additionally, the SLM system 114 may be used to impart a modulation pattern to the optical imaging light, allowing the use of structured illumination imaging techniques.

The controller 170 may be capable of estimating a flat-field response of the large-area microstereolithography system or of the optical imaging system 118 using multiple images of the product at different positions. For example, a single point of illumination may be directed to the build plane 190 by, for example, allowing only a single pixel of the SLM system 114 to transmit illumination light. This may illuminate a single pixel of the imaging element 250 in the optical imaging system 118. The illumination may then be moved such that a different pixel is illuminated. This procedure may be repeated for substantially all of the pixels of the imaging element 250 in the optical imaging system 118. Alternatively, the illumination light may be directed to multiple pixels and may then be moved. By obtaining a sufficient number of these images, the flat-field response of the imaging element 250 in the optical imaging system 118 may be obtained using, for instance, a deconvolution operation.

The controller 170 may be capable of calibrating one or more pixels of the SLM system 114. For example, in some embodiments, the controller 170 is capable of greyscaling the slice 140, the plurality of regions 150, or the current region 160 prior to directing illumination light to the SLM system 114. If some pixels of the SLM system 114 are brighter than others, the average optical power over the entire SLM system 114 may be homogenized by applying an appropriate greyscale mask. This may allow the SLM system 114 to achieve a more uniform illumination power across the build plane 190.

The controller 170 may be capable of directing the SLM system 114 to adjust a focus of the illumination light or the modulated illumination light. In some embodiments, the focus of the illumination light or the modulated illumination light is adjusted by translating a lens (not shown in FIG. 1 or FIG. 2) that collimates light from the SLM system 114. In some embodiments, the controller 170 instructs the lens to make such a change in position. In some embodiments, the focus of the illumination light or the modulated illumination light is adjusted by translating the SLM system 114. In some embodiments, the controller 170 instructs the SLM system 114 to make such a change in position. In some embodiments, the focus of the illumination light or the modulated illumination light is adjusted by using one or more mirrors (not shown in FIG. 1 or FIG. 2) that can be translated to change an optical path length of the illumination light or the modulated illumination light. In some embodiments, the controller 170 instructs the one or more mirrors to make such a change in position. In some embodiments, the focus of the illumination light or the modulated illumination light is adjusted by moving the entire system 100. In some embodiments, the controller 170 instructs the entire system 100 to make such a change in position. In some embodiments, the focus of the illumination light or the modulated illumination light is adjusted by moving the build plane 190. In some embodiments, the controller 170 instructs the build plane 190 to make such a change in position.

In some embodiments, the controller 170 is capable of performing closed-loop control of the illumination light or the modulated illumination light. For example, in some embodiments, the controller 170 is capable of directing the beam unit 110 to adjust an intensity or exposure time of the light beam 113 based on a measured total optical power emitted by the beam unit 110. In some embodiments, the controller 170 is capable of directing the beam unit 110 to adjust an intensity or exposure time of the light beam 113 based on a measured fluorescence, scattering, or reflection signal at the build plane 190. In some embodiments, the controller 170 is capable of directing the SLM system 114 to adjust a modulation of one or more pixels of the SLM system 114 or an exposure time based on a measured total optical power emitted by the SLM system. In some embodiments, the controller 170 is capable of directing the SLM system 114 to adjust a modulation of one or more pixels of the SLM system 114 or an exposure time based on a measured fluorescence signal at the build plane 190.

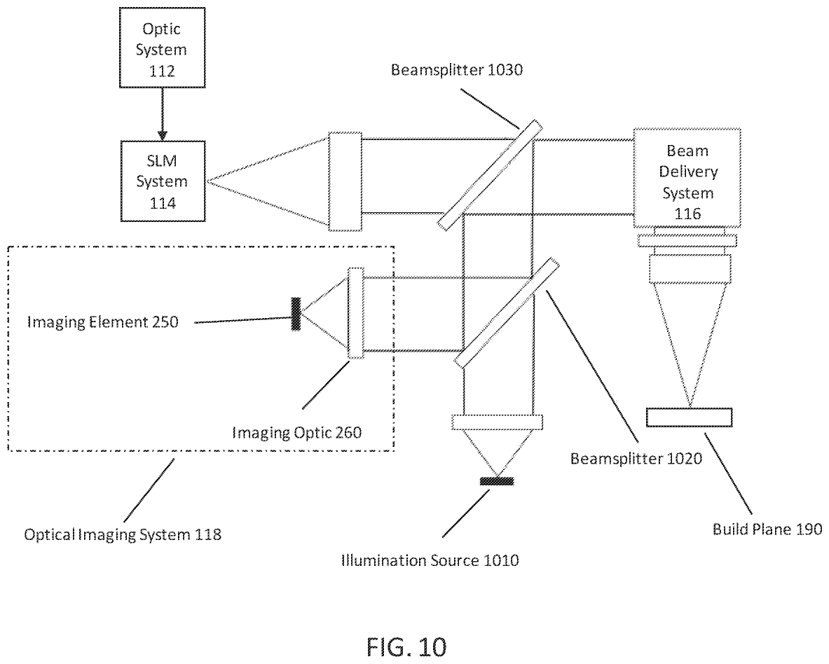

The OCLAuSL system 100 may also include other optical components in other locations (e.g., between the SLM 114 and the beam steering system 230, downstream of the common lens or aperture 180, etc.) as needed or as may occur to a person of ordinary skill in the art to direct and align the beam. For example, the conditioning optics 220, beam delivery optics 240, and/or imaging optics 210 may be or may include a beamsplitter capable of: (i) accepting the modulated illumination light from the SLM system 114 and directing the modulated illumination light to the selected build region 197 of the build plane 190; and (ii) accepting imaging light from the object or product being fabricated by the system, and directing the imaging light to the optical imaging system 118, as shown in FIG. 10. Such configurations, and others, fall within the scope of the present disclosure.

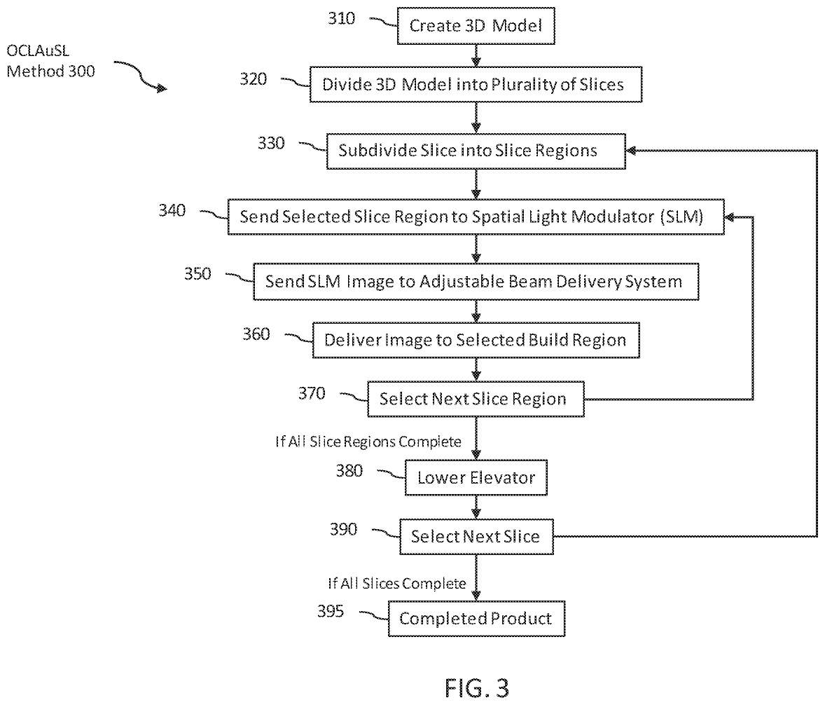

FIG. 3 shows a flow diagram of an example optically calibrated, large-area microstereolithography (OCLAuSL) method 300, in accordance with at least one embodiment of the present disclosure. The elevator motion, beam on/off, and imaging display are controlled and synchronized by the computer, controller, or processor.

In step 310, the method 300 includes creating a 3D model of a desired object or product. This may be done for example using computer aided design (CAD), through 3D scanning of an example of the desired object or product, or by other means known in the art. For example, the vasculature of a living human organ could be mapped in three dimensions using a computer-aided tomography (CAT) scanner and a contrast agent injected into the blood.

In step 320, the method 300 includes dividing the 3D model into a plurality of slices. The number of slices may for example determine the Z-resolution or Z-voxel size with which the desired object or product will be produced by the OCLAuSL system. For example, if the desired object or product is 100 centimeters tall, then subdividing it into 10,000 slices will result in a minimum feature size of 100 microns along the Z-axis.

In step 330, the method 300 includes subdividing a currently selected into slice regions. The slice may for example be subdivided into one, two, three, four, five, six, seven, eight, nine, ten, twenty, thirty, forty, fifty, sixty, seventy, eighty, ninety, one hundred, one thousand, ten thousand, or more slice regions. The slice regions may be of the same or similar size, or may be of different sizes. The slice regions may abut, may overlap, or may include a gap between neighboring slice regions.

In step 340, the method 300 includes sending a selected slice region to the spatial light modulator (SLM), such that the SLM generates an image of the selected slice region within the light beam produced by the optic system. In some examples, the brightness of each pixel of the SLM image may have only two possible values—on or off. In other examples, the brightness of each pixel of the SLM image may fall into a grayscale of, for example, 128, 256, 512, 1,024, or more possible values, with larger values representing brighter pixels and smaller values representing dimmer pixels.

In step 350, the method 300 includes sending the SLM image to the adjustable beam delivery system.

In step 360, the method 300 includes instructing the adjustable beam delivery system to direct the SLM image onto a selected build region of the build plane whose position within the build plane corresponds to the position of the selected slice region within the selected 2D slice. The projected image is in focus at the build plane, which contains a photocurable resin or liquid, such that the actinic light forms certain shapes or patterns within the material. This will expose the SLM image into the photosensitive liquid resin at this location, solidifying portions of the resin where the SLM image is bright and leaving unchanged the portions of the liquid resin there the SLM image is dark. Brighter pixels or longer exposure times will result in a greater energy dosage delivered to the resin and thus more cross-linking at that particular voxel within the build plane. Greater cross-linking may be associated with a denser and/or stiffer voxel of solidified resin, whereas less cross-linking may be associated with a less dense and/or more flexible voxel of solidified resin. When the cross-linking is complete, or at least sufficient for the pattern in the exposed region to retain its integrity, execution proceeds to step 370.

In step 370, the method 300 includes selecting the next slice region within the selected slice. Execution then returns to step 340. However, if all slice regions of the current slice have been imaged onto the build plane, then there is no next slice region, and execution proceeds to step 380.

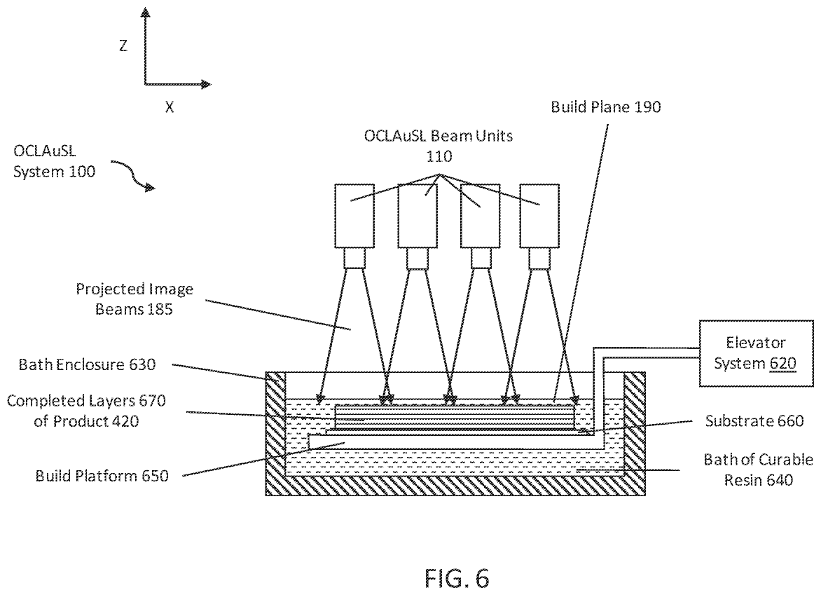

In step 380, the method 300 includes lowering the elevator platform within the resin bath. The elevator platform and resin bath are shown for example in FIG. 6. Lowering the elevator platform also lowers the current slice into a deeper level of the resin bath, and permits fresh resin to flow into the build plane. In some cases, the elevator platform is lowered by a Z-distance equal to the thickness of the current slice. In other examples, sometimes referred to as “dunking”, the elevator platform is lowered by a larger amount, and then raised to a Z-distance equal to the thickness of the current slice. Dunking permits fresh resin, unpolluted by cross-linking byproducts or containing equilibrium amounts of the locally depleted inhibitor and initiator, to flow into the build plane.

In step 390, the method 300 includes selecting the next slice in the 3D model. Execution then returns to step 330. However, if all the slices in the 3D model have previously been selected, then there is no next slice, and execution proceeds to step 395.

In step 395, the fabrication of the desired object or product is complete. In other words, the layer-by-layer process defined above has continued until a completed 3D object is fabricated.

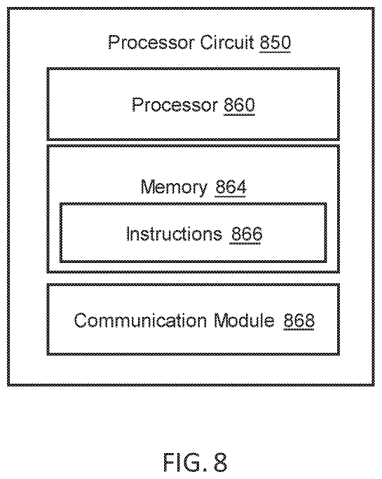

It is understood that the steps of method 300 may be performed in a different order than shown in FIG. 3, additional steps can be provided before, during, and after the steps, and/or some of the steps described can be replaced or eliminated in other embodiments. One or more of steps of the method 300 can be carried by one or more devices and/or systems described herein, such as components of the controller 170 (see FIG. 1) and/or processor circuit 850 (See FIG. 8).

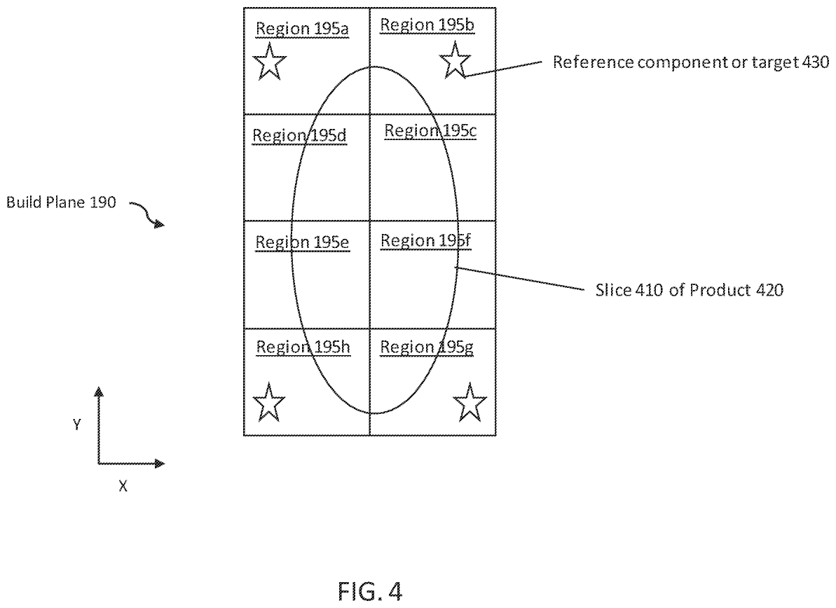

FIG. 4 is a schematic representation of at least a portion of the build plane 190 of an example OCLAuSL system, in accordance with at least one embodiment of the present disclosure. In the example shown in FIG. 4, the build plane 190 is subdivided into eight build regions 195a-195g. Spanning portions of all eight build regions is a product slice 410 of a product 420 being fabricated by the OCLAuSL system. The product slice 410 may for example comprise a plurality of exposed, cross-linked, solidified resin, such that a plurality if stacked product slices 410 make up the finished product 420.

In the example shown in FIG. 4, the build plane 190 also includes four reference components, targets, test substrates, or test patterns 430 that may be imaged by the optical imaging system 118 (See FIG. 1) to facilitate calibration of the OCLAuSL system by the controller 170 (See FIG. 1). In some embodiments, the reference components, targets, or test patterns 430 may be constructed within the build plane along with the product slice 410, e.g., by projecting them onto the build plane using actinic wavelengths of light capable of exposing or cross-linking the resin. In other embodiments, the reference components, targets, or test patterns 430 may be placed within the build plane, or may be projected onto the build plane using wavelengths of light incapable of exposing or cross-linking the resin. Reference targets or test patters may for example, have radial symmetry (e.g., dots), may have features of varying spatial frequency (e.g., line pairs of different widths), may have features of varying spatial frequency at different orientations (e.g., a spoke target), or may include recognizable text, symbols, or other features known in the art, including combinations thereof. The number, size, shape, position, orientation, and other properties of the reference components, targets, or test patterns 430 may be different than shown or described herein, without departing from the spirit of the present disclosure.

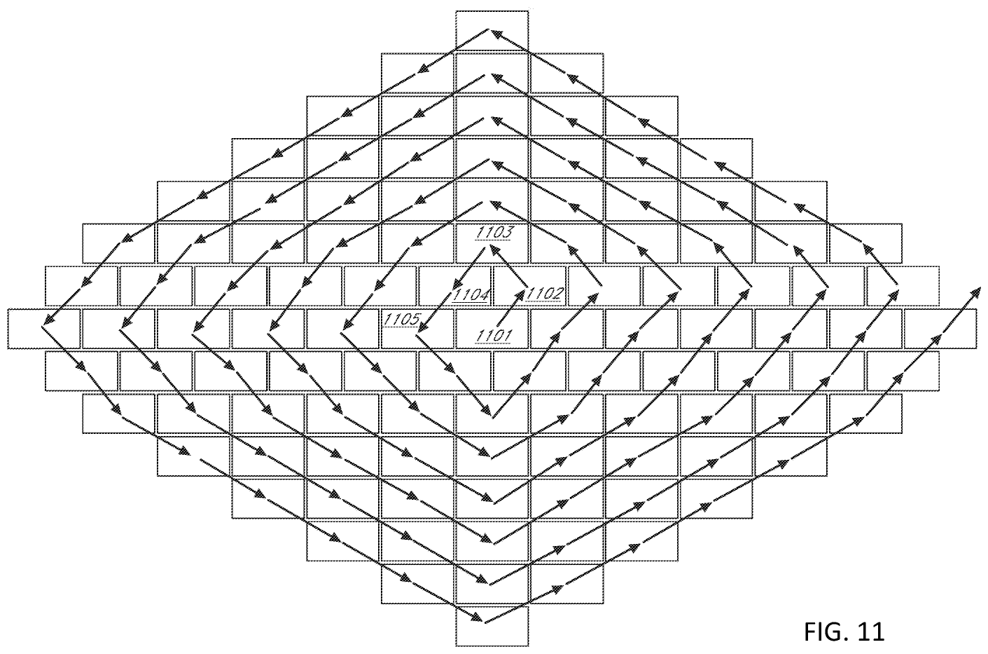

In an example, beam movement is minimized if the regions 195, as shown in FIG. 4, are exposed in alphabetical order: 195a, 195b, 195c, 195d, 195e, 195f, 195g, and finally 195h. It may be found that other orders are more efficient, such as a-d-e-h-g-f-c-b or any other possible order. Other continuous or discrete exposure patterns may also be desirable, including circles or spirals that minimize required beam movement and/or total exposure time required to complete a layer. More generally, the exposure pattern may be chosen so as to minimize the time required to move an optical element that refocuses the projection between subsequent exposures. The spiral pattern is an example of this, because the refocusing element doesn't have to move as far. Alternatively, the exposure pattern may be chosen so as to minimize the average or maximum time between exposure of any given tile and exposure of its adjacent or overlapping neighbors. A raster scan does a good job of this. In some cases, this can reduce the appearance of seams between adjacent or overlapping tiles. Other arrangements and optimizations, including combinations thereof, may be used instead or in addition. Exposure patterns taking the form of circles or spirals may allow the generation of more uniform layers or may reduce artifacts at the borders between regions in a given layer. Such patterns may place a greater emphasis on the generation of structures near the center of a given layer, where more detailed structures may be required. An example of a spiral pattern is shown in FIG. 11. In some embodiments, the scan pattern comprises a spiral pattern inward from a periphery of the build plane, a raster scan pattern, a scan pattern comprising a plurality of concentric circles, or an S-curve pattern.

The resolution and voxel size of the finished object or product 420 depend on the resolution of the SLM 114 (see FIGS. 1 and 2) and the size of each build region 195 within the build plane 190. Similarly, the maximum size of the finished object or product 420 depends on the number and arrangement of build regions, as well as their size. For example, if each of the eight build regions 195 shown in FIG. 4 is 1024×768 millimeters in size, and the resolution of the SLM 114 is 1024×768 pixels, then the voxel size in the build plane will be 1×1 mm, and the total area of the build plane will be 2048×3072 mm, and can be increased by adding new build regions.

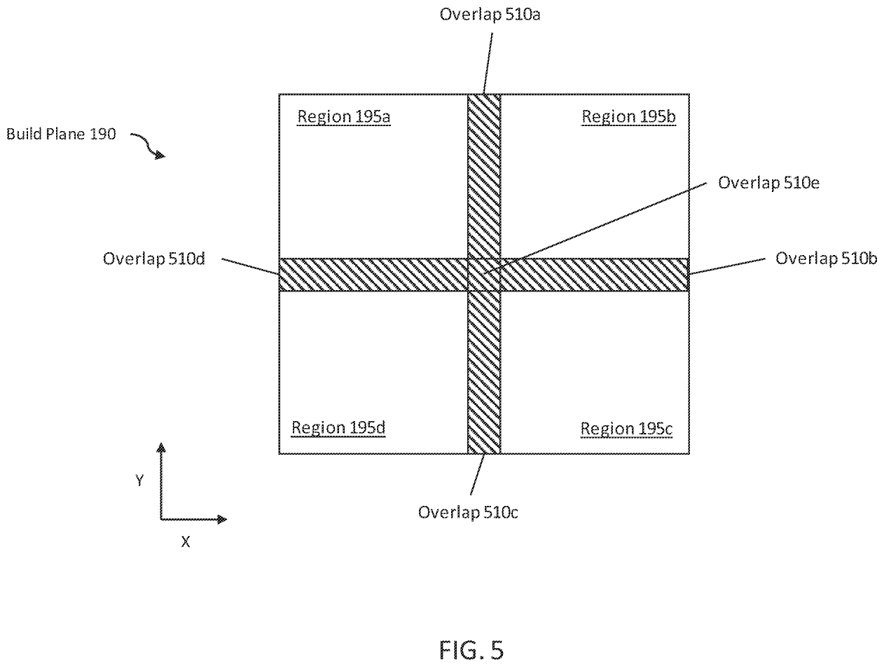

FIG. 5 is a schematic representation of at least a portion of the build plane 190 of an example OCLAuSL system, in accordance with at least one embodiment of the present disclosure. Visible are the build regions 195a, 195b, 195c, and 195d. In the example shown in FIG. 5, these build regions overlap, such that there is an overlap region 510a that includes portions of both build region 195a and build region 195b, an overlap region 510b that includes portions of build regions 195b and 195c, an overlap region 510c that includes portions of build regions 195c and 195d, an overlap region 510d that includes portions of build regions 195d and 195a, and an overlap portion 510e that includes portions of build regions 195a, 195b, 195c and 195d. When build regions abut, or when a gap exists between two build regions, a seam may be created (whether inadvertently or deliberately) in the finished product. Conversely, when build regions overlap, assuming proper registration between build regions, seams may be minimized or eliminated, and thus the overall quality of the product may be (or may be perceived as) greater than if seams are present.

FIG. 6 is a schematic, side cross-sectional view of at least a portion of an example OCLAuSL system 100, in accordance with at least one embodiment of the present disclosure. Visible are OCLAuSL beam units 110, projected image beams 185, an elevator system 620, and a bath of photocurable resin 640 positioned within a bath enclosure 640. Within the resin bath 640 are a build platform 650 connected to the elevator system 620, a substrate disposed on top of the build platform, and completed layers 670 of the desired object or product 420. Other arrangements are also possible and fall within the scope of the present disclosure.

The OCLAuSL system 100 can be improved by ganging multiple OCLAuSL beam units 110 together to produce an ultra large-area projection micro stereolithography system. Such ganging enables essentially limitless increase in the size of objects that can be fabricated by the system. The images exposed into the build plane by the two or more beam units 110 are coordinated together to utilize the larger overall area. With two beam units 110, the area covered is 2x minus the overlap area. Similarly, if three beam units 110 are combined they can cover 3x minus the overlap area, and so on. In this way larger and larger products can be manufactured.

In the non-limiting embodiment shown in FIG. 6, four OCLAuSL beam units 110 have been ganged together in such a way that their projected image beams 185 overlap slightly within the build plane 180. In some embodiments, the OCLAuSL beam units 110 may be controlled by a single controller 170 (see FIG. 1) such that their actions coordinate to form a 2D slice 410 of the desired product 420 within the build plane 190. In other embodiments, each OCLAuSL beam unit 110 may be controlled its own controller 170, with the controllers 170 coordinating their activities to achieve a comparable level of coordination. Other arrangements are also possible and fall within the scope of the present disclosure.

As can be seen in FIG. 6, the build plane 190 is positioned at the top portion of a bath of photocurable resin 640. The bath of photocurable resin may be tens or hundreds of centimeters long, wide, or deep, or may be other sizes both larger and smaller.

In some embodiments, the resin comprises a relatively soft, hydrophilic polymer-based material. In a non-limiting example, the main resin components may include: a monomer or polymer such as polyethylene glycol diacrylate (PEGDA, molecular weights over 575, specifically 575-6000), and/or gelatin methacrylate (GelMA); a photoinitiator such as lithium phenyl-2,4,6-trimethylbenzoylphosphinate (LAP), Irgacure 2959, and/or ruthenium; an absorber such as tartrazine; and a diluent such as PBS and/or water. Typical formulations may include 10-50 wt % of PEGDA (either mixture of single PEGDA of molecular weight 700-6000) or 10-25 wt % GelMA, 2-68 milliMoles (mM) LAP, 2-20 mM tartrazine, with the remaining wt % comprising water. One example formulation that has been shown to work well is 40 wt % PEGDA 6000, 34 mM LAP, 9 mM tartrazine, 15 wt % GelMA, 17 mM LAP, and 2.255 mM tartrazine. The term “resin” is to be interpreted broadly to include liquids, gels, solutions, suspensions, and colloids of plastic, monomeric based photocuring materials and/or softer, hydrophilic polymer based materials, or combinations thereof.

The disclosed apparatus and methods also provide an optically calibrated, large-area microstereolithography system for producing ceramic and/or metal parts. In an example, the beam delivery system projects and scans the layer images to a curable resin that includes metal or ceramic, whether suspended as particles, chemically bound as specialized molecules, or otherwise. The system then fabricates a desired object or product with a base polymer that contains metal or ceramic dispersed throughout the object. In some cases, this can result in a material with blended properties, such as an electrically conducting polymer or a polymer with higher than usual tensile or compressive strength. In other cases, the base polymer is subsequently removed by thermal decomposition, leaving behind a product made up of colloidal metal or ceramic particles. In some cases, these colloidal particles can be sintered to form a solid material.

In an example, the thickness of the build plane is (within reasonable mechanical tolerances expected by a skilled practitioner of the art) equal to the thickness of a slice 140 of the 3D model 120 (see FIG. 1). At the start of a product fabrication, the build plane 190 may be positioned between the substrate 660 and the top surface of the bath of photocurable resin 640, and may comprise a layer of liquid photocurable resin equal in thickness to the desired product slice 140.

Each time a new layer 670 is completed (e.g., fully cured, or at least partially cured enough for the newly created structures in the layer to maintain their integrity), the elevator system 620 moves the build platform 650 and substrate 660 downward in the resin bath by a distance equal to the thickness of the next slice 140. In some embodiments, all slices 140 are of equal thickness, but in other embodiments the slices 140 may be of varying thicknesses. In some embodiments, the elevator system 620 “dunks” the build platform 650, substrate 660, and completed layers 670 by lowering them in the z-direction by a distance greater than the desired slice thickness (e.g., 10 times, 100 times, 1,000 times, or 10,000 times the slice thickness, or other values both larger and smaller), and then raised them to the height of the desired slice thickness. In some cases, photocuring of a product layer 670 produces chemical byproducts or impurities (including but not limited to oxidants, radicals, microscopic particles of partially cross-linked resin, and side reaction products) that may interfere with photocuring of the next layer. This dunking process may help disperse such byproducts or impurities within the resin bath, and ensure that the build plane 190 is occupied by a clean layer of unreacted resin. The above describes a top-down system. It is to be understood that the present disclosure also includes bottom-up and sideways embodiments with appropriately oriented elevator systems.

In some embodiments, the elevator may be coupled to the build platform by an arm hanging over the edge of the vat, or by a post or set of shafts passing through the bottom of the vat. In some examples, the shafts may pass through o-rings or other seals to prevent resin from leaking around them. In some embodiments, the elevator system includes a stage that is movable on the Z-axis using servo or stepper motor under the control of a processor, such as the controller 170 of FIG. 1.

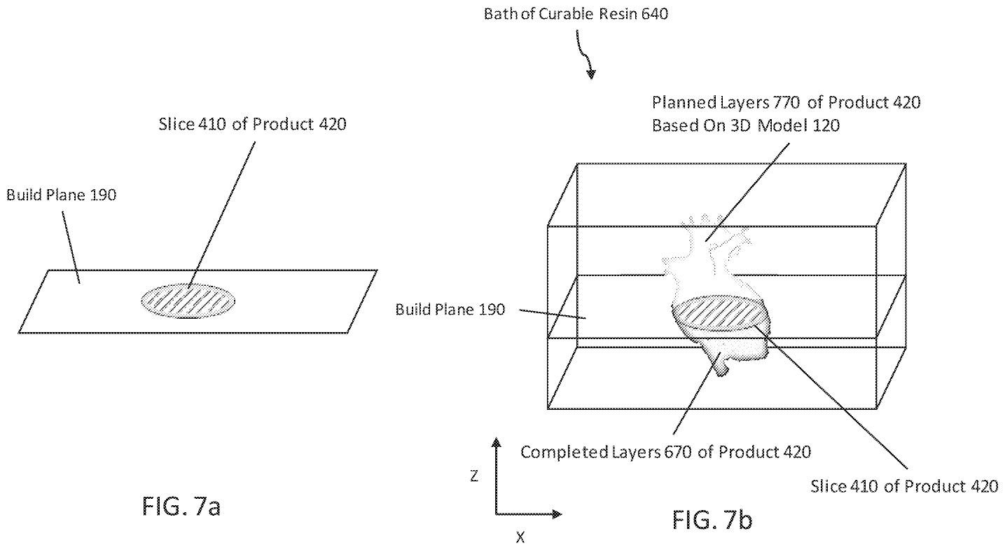

FIG. 7a is a perspective view of at least a portion of the build plane 190 of an example OCLAuSL system 100, in accordance with at least one embodiment of the present disclosure. Visible within the build plane 190 is a slice 410 of the desired object or product 420. The structure of the product slice 410 mimics the structure of a particular model slice 140 of the 3D model 120 (see FIG. 1). The product slice 410 may be a continuous solid piece, or may be made of discrete solidified voxels or other structures that do not necessarily connect within the build plane. In this way, three-dimensional lattices, networks, foams, and other complex 3D shapes — including macroscopic shapes with microscopic structural features — can be formed as new patterns are exposed, layer by layer.

FIG. 7b is a perspective view of at least a portion of the bath of curable resin 640 of an example OCLAuSL system 100, in accordance with at least one embodiment of the present disclosure. Visible are the completed layers 670 of the desired object or product 420, along with the layer or slice 410 that is currently under production, which is positioned at the top of the completed layers 670. Also visible in FIG. 7b are the planned layers 770 of the desired object or product 420. These planned layers may represent the contents of the plurality of slices 130 of the 3D model 120, as shown for example in FIG. 1. The 3D model 120 of the desired object or product 420 may include a mixture of macroscopic and microscopic features, whether similar or dissimilar to one another.

In some examples, the photocurable resin, when cured, yields a flexible material similar in consistency to human collagen or other human tissue components. In such examples, desired object or product may be a 3D representation of the vasculature, cartilage, or other portions of a synthetic human organ, into which human cells can be introduced to produce a completed synthetic organ. Partial organs, animal organs, organoids, grafts, and other tissues may be similarly produced. In some cases, the polymer material may then be removed from the completed product. For example, the polymer material may be removed mechanically, by dissolution, by chemical breakdown, by changes in pH, or by catalysis (such as enzymatic catalysis).

FIG. 8 is a schematic diagram of a processor circuit 850, according to embodiments of the present disclosure. The processor circuit 850 may for example be implemented in the controller 170 of the OCLAuSL beam unit 110 (see FIG. 1), or in other devices or workstations (e.g., third-party workstations, network routers, etc.), or on a cloud processor or other remote processing unit, as necessary to implement the method. As shown, the processor circuit 850 may include a processor 860, a memory 864, and a communication module 868. These elements may be in direct or indirect communication with each other, for example via one or more buses.

The processor 860 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 860 may also comprise another hardware device, a firmware device, or any combination thereof configured to perform the operations described herein. The processor 860 may also be implemented as a combination of computing devices, e.g., a combination of a DSP and a microprocessor, a plurality of microprocessors, one or more microprocessors in conjunction with a DSP core, or any other such configuration.

The memory 864 may include a cache memory (e.g., a cache memory of the processor 860), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 864 includes a non-transitory computer-readable medium. The memory 864 may store instructions 866. The instructions 866 may include instructions that, when executed by the processor 860, cause the processor 860 to perform the operations described herein. Instructions 866 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 868 can include any electronic circuitry and/or logic circuitry to facilitate direct or indirect communication of data between the processor circuit 850, and other processors or devices. In that regard, the communication module 868 can be an input/output (I/O) device. In some instances, the communication module 868 facilitates direct or indirect communication between various elements of the processor circuit 850 and/or the controller 170 (see FIG. 1). The communication module 868 may communicate within the processor circuit 850 through numerous methods or protocols. Serial communication protocols may include but are not limited to US SPI, I²C, RS-232, RS-485, CAN, Ethernet, ARINC 429, MODBUS, MIL-STD-1553, or any other suitable method or protocol. Parallel protocols include but are not limited to ISA, ATA, SCSI, PCI, IEEE-488, IEEE-1284, and other suitable protocols. Where appropriate, serial and parallel communications may be bridged by a UART, USART, or other appropriate subsystem.

External communication (including but not limited to software updates, firmware updates, preset sharing between the processor and central server, or readings from the system) may be accomplished using any suitable wireless or wired communication technology, such as a cable interface such as a USB, micro USB, Lightning, or FireWire interface, Bluetooth, Wi-Fi, ZigBee, Li-Fi, or cellular data connections such as 2G/GSM, 3G/UMTS, 4G/LTE/WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

FIG. 9 shows an example of an optical imaging system that is physically separated from the optic system, the SLM system, and the beam delivery system of an optically calibrated large-area microstereolithography system. As shown in FIG. 9, the optic system 112, SLM system 114, and beam delivery system 116 may be located at a distance from the optical imaging system 118. For example, the optic system 112, SLM system 114, and beam delivery system 116 may each be located at least about 10 cm, 20 cm, 30 cm, 40 cm, 50 cm, 70 cm, 80 cm, 90 cm, 100 cm, or more from the optical imaging system 118. The optic system 112, SLM system 114, and beam delivery system 116 may each be located at most about 100 cm, 90 cm, 80 cm, 70 cm, 60 cm, 50 cm, 40 cm, 30 cm, 20 cm, 10 cm, or less from the optical imaging system 118. The optic system 112, SLM system 114, and beam delivery system 116 may each be located a distance from the optical imaging system 118 that is within a range defined by any two of the preceding values. Having the optic system 112, SLM system 114, and beam delivery system 116 each located a distance from the optical imaging system 118 may allow the use of imaging optics 260 that are not subject to the constraints of the lens or aperture 180 that is used to project the projected image beam to the build plane 190. For example, the lens or aperture 180 may be configured to efficiently transmit blue light to the build plane 190. It may be desirable to image other wavelengths of light, such as light in the green, yellow, red, or infrared parts of the electromagnetic spectrum. It may be difficult to project light in the blue and image light in these other regimes, as there may be few materials that transmit both blue light and light in these other regimes.

In some embodiments, it may be desirable to image through some of the same optics that are used to project the illumination light. For instance, FIG. 10 shows an example of an optically calibrated, large-area microstereolithography system that utilizes a beamsplitter or dichroic to perform large-area microstereolithography and optical imaging through common optical elements. As shown in FIG. 10, the optically calibrated, large-area microstereolithography system may comprise optic system 112, SLM system 114, beam delivery system 116, and optical imaging system 118, as described herein. The system may further comprise an illumination source 1010 capable of emitting imaging illumination light (for example, for fluorescence imaging). The illumination source may direct imaging illumination light through a first beamsplitter or dichroic 1020 and to a second beamsplitter or dichroic 1030. The imaging illumination light may then be directed through the beam delivery system 116 and any conditioning optics toward the build plane 190. The optic system 112 and SLM system 114 may direct modulated illumination light toward the second beamsplitter 1030, which may pass the modulated illumination light to the beam delivery system 116 and the build plane 190. When the imaging illumination light interacts with the product at the build plane, imaging light (such as fluorescence light) may be emitted by the product. This imaging light may then travel through optical elements such as the first beamsplitter 1020. Because this imaging light may have a different wavelength than the imaging illumination light, it may be directed to imaging optic 260 and detected by imaging element 250. In this manner, the first and second beamsplitter 1020 and 1030, respectively, may allow imaging through some of the same optics that are used to project the illumination light.

FIG. 11 shows an exemplary spiral scan pattern. As shown in FIG. 11, the scan starts with a first region 1101 located near the center of the product. The scan then moves in a spiral pattern outward to a second region 1102, a third region 1103, a fourth region 1104, a fifth region 1105, and so forth as indicated by the arrows. This process may be continued as indicated for any number of regions.

As will be readily appreciated by those having ordinary skill in the art after becoming familiar with the teachings herein, the optically calibrated, large-area microstereolithography system advantageously permits rapid, reliable, repeatable, fabrication of large objects (e.g., hundreds of millimeters or larger in size) with microscopic features (e.g., tens of microns or smaller in size), with few or no detectable seams and with pixelation occurring on a scale too fine to be perceived by the human eye. Accordingly, it can be seen that the optically calibrated, large-area microstereolithography system fills a need in the art, by providing a means to calibrate projected images, and the optics that produce them, in order to ensure a consistent size and curing level of voxels across the entire build plane, however large or small that may be.

A number of variations are possible on the examples and embodiments described above. For example, the build plane and/or resin bath may be larger or smaller than depicted herein. The resolution may be greater (or the voxel size may be smaller) than discussed herein, limited only by classical diffraction limits. Conversely, the technologies discussed herein may equally be applied to systems with extremely large build volumes and/or voxel sizes, for the production of industrial-scale components. Composition of the resin bath, and the corresponding actinic wavelengths capable of cross-linking the resin, may be different than disclosed herein. Cured resins may be transparent to infrared light, visible light, or ultraviolet light, or may be translucent or opaque, or combinations thereof. Resins may be or may include dye molecules or dye particles (including fluorescent molecules or particles) to confer any desired color or combination of colors to the finished part, including colors not perceivable by the human eye. The technology described herein may be employed to produce prototypes or finished goods (e.g., tools, housings, models, or components) for nearly any industry, including but not limited to medicine, art, science, manufacturing, agriculture, automotive, aerospace, and consumer electronics. Non-limiting examples include dental crowns and implants, biological scaffolds, implantable tissues and organs, supercapacitors, and food.

The logical operations making up the embodiments of the technology described herein are referred to variously as operations, steps, objects, elements, components, or modules. Furthermore, it should be understood that these may occur or be performed in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the optically calibrated microstereolithography system. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the optically calibrated microstereolithography system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

### Recitation of Various Embodiments of the Present Disclosure

Embodiment 1: A system for producing a product, comprising: a large-area micro-stereolithography system capable of generating the product by optically polymerizing successive layers of a curable resin at a build plane; an optical imaging system; and a controller in communication with the large-area micro-stereolithography system and the optical imaging system, the controller capable of: directing the optical imaging system to obtain one or more optical images of the product or of a reference component located at the build plane; and adjusting a parameter associated with the large-area micro-stereolithography system based on the one or more images.

Embodiment 2: The system of embodiment 1, wherein the optical imaging system is located substantially near the build plane.

Embodiment 3: The system of embodiment 1 or 2, wherein the optical imaging system comprises a bright field imaging system, fluorescence imaging system, reflectance imaging system, scattering imaging system, refractive index difference imaging system, luminescence imaging system, ellipsometry imaging system, differential interference contrast imaging system, phase contrast microscopy imaging system, Raman scattering imaging system, spectral imaging system, optical coherence tomography (OCT) imaging system, or interferometric imaging system.

Embodiment 4: The system of any of embodiments 1-3, wherein the controller is further capable of processing the one or more optical images of the product to identify a first region of the product comprising cured resin and a second region of the product comprising uncured resin and wherein adjusting the parameter based on the one or more images comprises: (i) comparing the first region of the product with an intended first region of the product, (ii) comparing the second region of the product with an intended second region of the product, and (iii) adjusting the parameter to reduce a first difference between the first region of the product and the intended first region of the product and a second difference between the second region of the product and the intended second region of the product.

Embodiment 5: The system of any of embodiments 1-4, wherein the controller is further capable of processing the one or more optical images of the product to determine a physical or chemical property of the product and wherein adjusting the parameter based on the one or more comprises: (i) comparing the physical or chemical property of the product with an intended physical or chemical property of the product and (ii) adjusting the parameter to reduce a difference between the physical or chemical property of the product and the intended physical or chemical property of the product.

Embodiment 6: The system of any of embodiments 1-5, wherein the parameter comprises an intensity of illumination light emitted by the large-area micro-stereolithography system, a focus of the illumination light, an exposure time of the illumination light, or a frequency of the illumination light.

Embodiment 7: The system of any of embodiments 1-6, further comprising a non-optical imaging system, and wherein the controller is further capable of directing the non-optical imaging system to obtain one or more non-optical images of the product.

Embodiment 8: The system of embodiment 7, wherein the non-optical imaging system comprises an ultrasound imaging system or photoacoustic imaging system.

Embodiment 9: The system of any of embodiments 1-8, further comprising a substantially uniformly luminescent surface substantially near the build plane, wherein the controller is further capable of: (i) directing illumination light from the large-area micro-stereolithography system to illuminate the substantially uniformly luminescent surface, (ii) directing the optical imaging system to obtain one or more images of the substantially uniformly luminescent surface, and (iii) calibrating the large-area micro-stereolithography system based on the one or more images.

Embodiment 10: The system of embodiment 9, wherein the illumination light comprises Kohler illumination light.

Embodiment 11: The system of any of embodiments 1-10, wherein the controller is further capable of estimating a flat-field response of the optical imaging system based on the one or more optical images.

Embodiment 12: The system of any of embodiments 1-11, further comprising a test substrate located substantially near the build plane, and wherein the controller is further capable of: (i) directing illumination light from the large-area micro-stereolithography system or another illumination source to illuminate the test substrate, (ii) directing the optical imaging system to obtain one or more test images of the test substrate, and (iii) calibrating the large-area micro-stereolithography system based on the one or more test images.

Embodiment 13: The system of any of embodiments 1-12, wherein the large-area micro-stereolithography system comprises: an optic system; a spatial light modulator (SLM) system; a bath comprising the curable resin, wherein the build plane is located within the bath; an elevator system; and a large-area micro-stereolithography controller capable of: receiving a plurality of two-dimensional slices of the product, the plurality of two-dimensional slices corresponding to a three-dimensional model of the product; for each two-dimensional slice of the plurality of two-dimensional slices: dividing the two-dimensional slice into a plurality of regions; for each region of the plurality of regions: directing the optic system to provide illumination light to the SLM system; directing the SLM system to modulate the illumination light based on the region to form modulated illumination light; and directing the beam delivery system to deliver the modulated illumination light to the build plain, thereby generating a portion of a layer of the product in the curable resin, the portion corresponding to the region and the layer corresponding to the two-dimensional slice; and directing the elevator system to raise or lower the build plane based on the three-dimensional model to thereby change a position of the build plane in the bath.

Embodiment 14: The system of embodiment 13, wherein the beam delivery system comprises a spinning polygonal mirror.

Embodiment 15: The system of embodiment 13 or 14, wherein the optic system, the SLM system, and the beam delivery system are physically separated from the optical imaging system.

Embodiment 16: The system of any of embodiments 13-15, further comprising a beamsplitter capable of: (i) accepting the modulated illumination light from the SLM system and directing the modulated illumination light to the build plane; and (ii) accepting imaging light from the product and directing the imaging light to the optical imaging system.

Embodiment 17: The system of any of embodiments 13-16, wherein the controller is further capable of calibrating one or more pixels of the SLM system.

Embodiment 18: The system of any of embodiments 13-17, further comprising a lens capable of collimating the illumination light or the modulated illumination light.

Embodiment 19: The system of any of embodiments 13-18, wherein the large-area micro-stereolithography controller is further capable of directing the SLM system to adjust a focus of the illumination light or the modulated illumination light.

Embodiment 20: The system of any of embodiments 13-19, further comprising one or more mirrors capable of altering an optical path length of the illumination light or the modulated illumination light.

Embodiment 21: The system of any of embodiments 13-20, wherein the large-area micro-stereolithography controller is further capable of directing the curable resin bath to move relative to the optic system, the SLM system, the beam delivery system, or the optical imaging system.

Embodiment 22: The system of any of embodiments 13-21, wherein the large-area micro-stereolithography controller is further capable of directing the illumination light through the SLM system.

Embodiment 23: The system of any of embodiments 13-22, further comprising one or more filters capable of filtering one or more wavelengths of the illumination light or the modulated illumination light.

Embodiment 24: The system of any of embodiments 13-23, wherein the beam delivery system is capable of delivering the modulated illumination light in a spiral pattern outward from a center of the build plane, a spiral pattern inward from a periphery of the build plane, a raster scan pattern, a scan pattern comprising a plurality of concentric circles, or an S-curve pattern.

Embodiment 25: A method for producing a product, comprising: generating the product by optically polymerizing successive layers of a curable resin at a print plane using a large-area micro-stereolithography system; using the optical imaging system to obtain one or more optical images of the product; and adjusting a parameter associated with the large-area micro-stereolithography based on the one or more images.

What is claimed is:

1. A system for producing a product, comprising:
a large-area micro-stereolithography system capable of generating the product by optically polymerizing successive layers of a curable resin at a build plane;
an optical imaging system; and
a controller in communication with the large-area micro-stereolithography system and the optical imaging system, the controller capable of:
directing the optical imaging system to obtain one or more optical images of the product or of a reference component located at the build plane; and
adjusting a parameter associated with the large-area micro-stereolithography system based on the one or more images.

2. The system of claim 1, wherein the optical imaging system is located substantially near the build plane.

3. The system of claim 1, wherein the optical imaging system comprises a bright field imaging system, fluorescence imaging system, reflectance imaging system, scattering imaging system, refractive index difference imaging system, luminescence imaging system, ellipsometry imaging system, differential interference contrast imaging system, phase contrast microscopy imaging system, Raman scattering imaging system, spectral imaging system, optical coherence tomography (OCT) imaging system, or interferometric imaging system.

4. The system of claim 1, wherein the controller is further capable of processing the one or more optical images of the product to identify a first region of the product comprising cured resin and a second region of the product comprising uncured resin and wherein adjusting the parameter based on the one or more images comprises: (i) comparing the first region of the product with an intended first region of the product, (ii) comparing the second region of the product with an intended second region of the product, and (iii) adjusting the parameter to reduce a first difference between the first region of the product and the intended first region of the product and a second difference between the second region of the product and the intended second region of the product.

5. The system of claim 1, wherein the controller is further capable of processing the one or more optical images of the product to determine a physical or chemical property of the product and wherein adjusting the parameter based on the one or more comprises: (i) comparing the physical or chemical property of the product with an intended physical or chemical property of the product and (ii) adjusting the parameter to reduce a difference between the physical or chemical property of the product and the intended physical or chemical property of the product.

6. The system of claim 1, wherein the parameter comprises an intensity of illumination light emitted by the large-area micro-stereolithography system, a focus of the illumination light, an exposure time of the illumination light, or a frequency of the illumination light.

7. The system of claim 1, further comprising a non-optical imaging system, and wherein the controller is further capable of directing the non-optical imaging system to obtain one or more non-optical images of the product.

8. The system of claim 7, wherein the non-optical imaging system comprises an ultrasound imaging system or photoacoustic imaging system.

9. The system of claim 1, further comprising a substantially uniformly luminescent surface substantially near the build plane, wherein the controller is further capable of: (i) directing illumination light from the large-area micro-stereolithography system to illuminate the substantially uniformly luminescent surface, (ii) directing the optical imaging system to obtain one or more images of the substantially uniformly luminescent surface, and (iii) calibrating the large-area micro-stereolithography system based on the one or more images.

10. The system of claim 9, wherein the illumination light comprises Kohler illumination light.

11. The system of claim 1, wherein the controller is further capable of estimating a flat-field response of the optical imaging system based on the one or more optical images.

12. The system of claim 1, further comprising a test substrate located substantially near the build plane, and wherein the controller is further capable of: (i) directing illumination light from the large-area micro-stereolithography system or another illumination source to illuminate the test substrate, (ii) directing the optical imaging system to obtain one or more test images of the test substrate, and (iii) calibrating the large-area micro-stereolithography system based on the one or more test images.

13. The system of claim 1, wherein the large-area micro-stereolithography system comprises:
an optic system;
a spatial light modulator (SLM) system;
a bath comprising the curable resin, wherein the build plane is located within the bath; an elevator system; and
a large-area micro-stereolithography controller capable of:
receiving a plurality of two-dimensional slices of the product, the plurality of two-dimensional slices corresponding to a three-dimensional model of the product;
for each two-dimensional slice of the plurality of two-dimensional slices:
dividing the two-dimensional slice into a plurality of regions;
for each region of the plurality of regions:
directing the optic system to provide illumination light to the SLM system;
directing the SLM system to modulate the illumination light based on the region to form modulated illumination light; and
directing the beam delivery system to deliver the modulated illumination light to the build plain, thereby generating a portion of a layer of the product in the curable resin, the portion corresponding to the region and the layer corresponding to the two-dimensional slice; and
directing the elevator system to raise or lower the build plane based on the three-dimensional model to thereby change a position of the build plane in the bath.

14. The system of claim 13, wherein the beam delivery system comprises a spinning polygonal mirror.

15. The system of claim 13, wherein the optic system, the SLM system, and the beam delivery system are physically separated from the optical imaging system.

16. The system of claim 13, further comprising a beamsplitter capable of: (i) accepting the modulated illumination light from the SLM system and directing the modulated illumination light to the build plane; and (ii) accepting imaging light from the product and directing the imaging light to the optical imaging system.

17. The system of claim 13, wherein the controller is further capable of calibrating one or more pixels of the SLM system.

18. The system of claim 13, further comprising a lens capable of collimating the illumination light or the modulated illumination light.

19. The system of claim 13, wherein the large-area micro-stereolithography controller is further capable of directing the SLM system to adjust a focus of the illumination light or the modulated illumination light.

20. The system of claim 13, further comprising one or more mirrors capable of altering an optical path length of the illumination light or the modulated illumination light.

21. The system of claim 13, wherein the large-area micro-stereolithography controller is further capable of directing the curable resin bath to move relative to the optic system, the SLM system, the beam delivery system, or the optical imaging system.

22. The system of claim 13, wherein the large-area micro-stereolithography controller is further capable of directing the illumination light through the SLM system.

23. The system of claim 13, further comprising one or more filters capable of filtering one or more wavelengths of the illumination light or the modulated illumination light.

24. The system of claim 13, wherein the beam delivery system is capable of delivering the modulated illumination light in a spiral pattern outward from a center of the build plane, a spiral pattern inward from a periphery of the build plane, a raster scan pattern, a scan pattern comprising a plurality of concentric circles, or an S-curve pattern.

25. A method for producing a product, comprising:
generating the product by optically polymerizing successive layers of a curable resin at a print plane using a large-area micro-stereolithography system;
using the optical imaging system to obtain one or more optical images of the product; and
adjusting a parameter associated with the large-area micro-stereolithography based on the one or more images.
